(19) United States
(12) Patent Application Publication
(10) Pub. No.: US 2010/0047000 A1
(43) Pub. Date: Feb. 25, 2010

(54) AUTOMATED METHOD AND SYSTEM FOR SELF-CALIBRATION OF IMAGE ON MEDIA SHEETS USING AN AUTO DUPLEX MEDIA PATH

(75) Inventors: Daniel Clark Park, West Linn, OR (US); John Timothy Howell, Tigard, OR (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/197,027

(22) Filed: Aug. 22, 2008

(51) Int. Cl. G03G 15/00

(52) U.S. Cl. 399/394

(57) ABSTRACT

Automated image on media registration and self-calibration using a built-in printing system duplex media path is enabled. The media sheet can be registered in a registration system and a calibration image can be placed on the media sheet after registration of the media. The media sheet can be inverted in the duplex media path and re-fed for detection of calibration image placement accuracy on the media sheet. The registration system can transmit the image registration placement data to a printer controller. Thereafter, the printer controller can adjust system settings to compensate for an image placement registration offset using a calibration algorithm. The invention enables system adjustments without requiring manual measurements or media transfer to an independent scanning device or adding complexity to printing systems.

### TECHNICAL FIELD

Embodiments are generally related to digital printing systems. Embodiments are more particularly related to an automated method and system for registration self-calibration of image on media sheets using an auto duplex media path. Embodiments are additionally related to registration systems with a calibration algorithm.

### BACKGROUND OF THE INVENTION

In printing industries, images on media such as paper in digital printing systems can require adherence to stringent quality standards. Quality of such images on the media should be maintained throughout printing, finishing and binding processes. The media should correctly be positioned before applying the image. Therefore, many printers contain active registration systems that correctly position and orient media prior to applying images to it. The purpose of the active registration systems is to properly register sheets of paper, transparency, card stock or other media. For example, a sheet of paper can be registered as a pair of nips such as wheels or rollers so that the image can be rendered in the appropriate location on the paper sheets. The terms printer or printers are intended to encompass all forms of imaging devices such as multi-function printers, FAX machines, copiers and the like. Media will often be referred to as paper for convenience, but it is to be understood that other media types are encompassed by the term paper in context with the present invention.

In a media registration system, multiple sensors can be utilized to detect the position and/or orientation of media relative to a process direction. The process direction can denote a main direction in which the media progresses. The speed or velocity of the nips can be represented as functions of time and controlled in a media registration process. An algorithm is necessary for controlling the speed or velocity of the nips in order to properly register the image on the paper sheet. Additionally, computational hardware can also be required to correct the media registration errors due to deviation of the paper sheet from an ideal nominal process velocity when it is moving along a path in the process direction.

An active registration system can also correct the media presentation to the imaging device along three different degrees of freedom such as process, lateral and skew. In process, the position of the media should be arranged along the direction in which the media normally travels in the media path. In lateral, the position of the media is orthogonal to the direction in which the media travels. Finally, in skew, the angular rotation of the media is relative to its nominal orientation. A competent media registration system can measure the incoming registration error when the sheet approaches the registration system in order to execute a proper profile to correct the error along three degrees of freedom. Two laterally separated point sensors may be utilized to detect the lead edge of the sheet when it moves underneath the sensors, which detect the process position and the skew of the sheet. A separate linear array sensor may be used to detect the lateral position of the sheet. Conversely, a printer may utilize a single linear array sensor in order to detect incoming process, lateral, and skew errors, which avoids the need of additional sensors and may require more elaborate operational algorithms.

In addition, calibration of the active registration systems is also required in order to correctly place the image on the media because of variations in manufacturing in both the media handling system and imaging system. Traditionally, the calibration can be achieved by manually scanning printed images on a flat bed scanner, which can be integrated or independent of the printer. Such a manual method needs a human operator to manually move the calibration image sheets from the output to the scanner. Additionally, calibration values may need to be inputted into user interface (UI) of the printer. The calibration can also be achieved by adding a sensing system in the media path after applying the image in order to evaluate and correct the image on media calibration values. The above-mentioned methods can add user complexity or production cost to a printer due to the necessity of scanner interaction or the additional sensors.

A need, therefore, exists for an automated method and system for self-calibration of image on media sheets using normally included printer elements and media path functionality, such as a media duplex function and an active media orientation and position registration mechanism, which can execute a calibration process without intervention from an operator or adding additional sensors. Such improved methods and systems are described in greater detail herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an automated method and system for registration self-calibration of image on media sheets using an auto duplex media path.

It is another aspect of the present invention to provide a self calibration algorithm using data from the registration system based on the relationship of a calibration image and media edges to provide offset correction values to achieve improved image to media placement registration.

The aforementioned aspects and other objectives and advantages can now be achieved as described herein. An automated method and system for registration self-calibration of image on media sheets using a built-in duplex media path is provided. Media misregistration is first determined by detection of a media sheet during initial sheet registration by the systems registration system. If misregistration is detected, the sheet is positioned by the registration mechanism. Once sheet registration is achieved, a calibration image can be placed on the sheet. The sheet can then be inverted in the duplex media path and re-fed into the registration sensing region of the media path where the accuracy of the calibration image placement on the registered sheet is assessed so a registration calibration value can be determined using a calibration algorithm. The registration calibration value is stored in a printer controller to be applied to media registration in subsequent print jobs.

Media sheets can be made available in a media tray in an ordered manner. For example, a paper sheet can be fed into a print engine for imaging after determining sheet alignment with a registration system and then correcting orientation and placement with a registration mechanism. The registration system can include a single linear array sensor, which captures image and edge data from the paper sheet after printing the calibration image on the paper sheet. Nominally registered media may not enable ideal placement of the image on the media relative to media edges due to numerous system, media and image errors or offsets.

The registration system determines media orientation and media path position based on sensors that detect the media so the paper path transport and guide elements can be utilized to influence media trajectory, positioning and phasing for proper registration of the media before application of the image. The term registration system encompasses sensors and the whole media sensing system as well as transport elements and/or guides that can be controlled to influence media position and/or orientation. A calibration value can be used to adjust the data available from the registration system to correct for system errors or offsets, thereby improving media registration to image placement accuracy. The system can utilize the registration system and the duplex media path in order to automatically self-calibrate registration for image placement on the media sheets without intervention from the operator or adding additional sensors.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1, labeled as “Prior Art”, illustrates a block diagram of components for a standard registration system typical of many printing devices;

FIG. 2 illustrates a schematic block diagram of processes for a registration system in accordance with features of the preferred embodiment;

FIG. 3 illustrates a flowchart of an automated method for self-calibration of image on the media sheets using the active registration system and the built-in auto duplex media path, which can be implemented in accordance with an alternative embodiment;

FIG. 4 illustrates a schematic representation of an example of a calibration image on the paper sheet, which can be implemented in accordance with a preferred embodiment; and

FIG. 5 illustrates a schematic view of a flow diagram of an example printing system with the active registration system and the built-in auto duplex media path, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

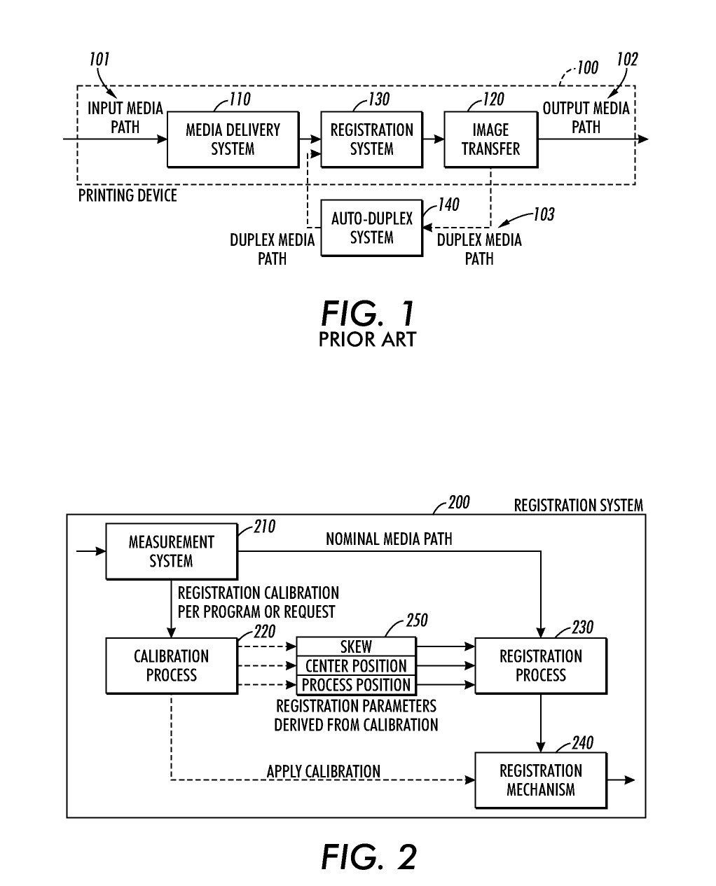

The present invention mainly focuses on input/output devices, such as a printing device like a printer, multi-function printing product or other imaging device, which may include a data-processing apparatus or capability, as desired. A standard registration system 100 typical of most printing devices is illustrated in FIG. 1, labeled “prior art.” A standard registration system can include a media delivery system module 110 having an input media path 101 associated with it, a registration system module 130, an image transfer module 120 coupled to an output media path 102 and a duplex media path 103 providing a route through an auto duplex system module 140 to the registration system module 130.

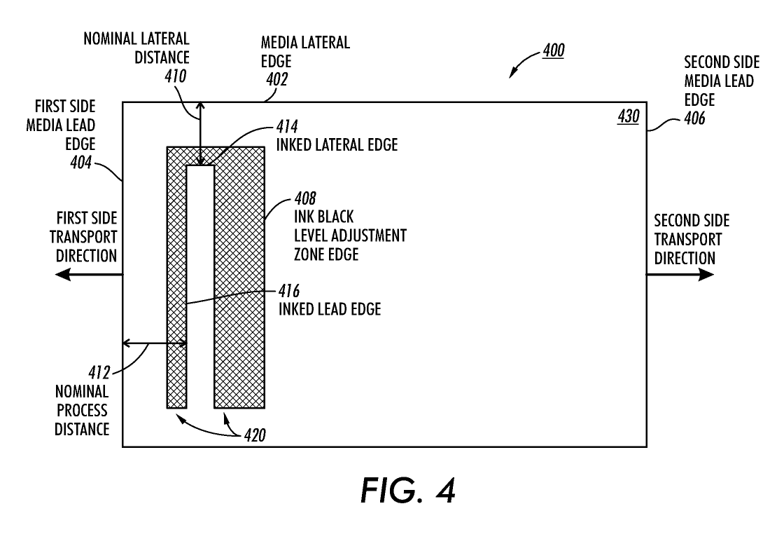

One or more application programs, such as image calibration application software, can be preprogrammed in the printer or subsequently “loaded” (i.e., transferred from storage into system memory) for execution of automatic self-calibration of the calibration image 400 location on a paper sheet 430, as shown in FIG. 4, by a data-processing apparatus. Image elements 420 included in a calibration image 400 may be different than shown in the example.

An interface, which is preferably a graphical user interface (GUI), may be used to control, initiate or program frequency, timing or other aspects of registration calibrations and/or display results. In an embodiment, an operating system with user interface can be implemented as a “Windows” like system or a menu selection interface, as examples. Calibration image calculations provided via a software program can include determining registration correction values based on image placement assessment and may additionally include operation instructions, such as specific media path cycling, position correction and image creation. Image alignment or placement is based on the image location on the media as directly printed or via the transfer surface of an offset print method such as an imaging drum. In direct or offset printing, placement of the image is a function of the relationship of independent media and image positioning.

Media is generally intended to pass through a printer along a fixed path and would travel in exactly this path absent imperfections, such as media size, system errors and part and assembly variations. The image is likewise generally laid down in a fixed region which would position the final image on the media as intended by the application with an idealized media interface. In more sophisticated printers, media positioning through the media feed path is adjustable or correctable so that a more idealized position and orientation may be attained prior to application of the image. In some cases it may be possible for image lay down over a normally fixed region to be adjusted or modified to accommodate media and system errors or offsets. The following descriptions pertain to either or a combination of media and image position adjustments to achieve improved image placement due to system and process imperfections that degrade desired image to media alignment.

Registration, as related to concepts of the present invention, refers to assessing the position and orientation of the media along the transport path against the ideal location that would allow nominal alignment or placement of the image on the media, data associated with that measurement and the position and orientation adjustment of the media and/or imaging placement subsequent to registration assessment and prior to receiving the image. Adjustment means and sensor or edge detection components that may be employed for this registration are described in numerous media handling patents and have become sufficiently commonplace to omit further description here, particularly since this invention is not dependent upon the specific processes and sensors or detectors that may be used. Duplexing, or two sided printing, is now a common feature of many printers. The duplex path is an alternate routing of the media back into the imaging region of the printer where media with only a first side image would otherwise follow an exit path. Since the normal purpose of the duplex path is to create an image on the second side of the media, the media is inverted or flipped side to side. Depending on the product and media path method, the media may go through this path with the original leading edge at the front or it may become the trailing edge.

FIG. 2 illustrates a schematic block diagram of a registration system 200 in accordance with features of the present invention. A registration system 200 is typically incorporated into a region of the media path ahead of or prior to the imaging or image application region of the printer. The calibration image and/or calibration algorithm may be downloaded as needed, or more preferably, be stored in system memory. An input media path can feed into a measurement system 210. Scan image data can flow from the measurement system 210 to the calibration process 220, which determines registration parameters 250 used in the registration process 230 to control a correction drive mechanism 240.

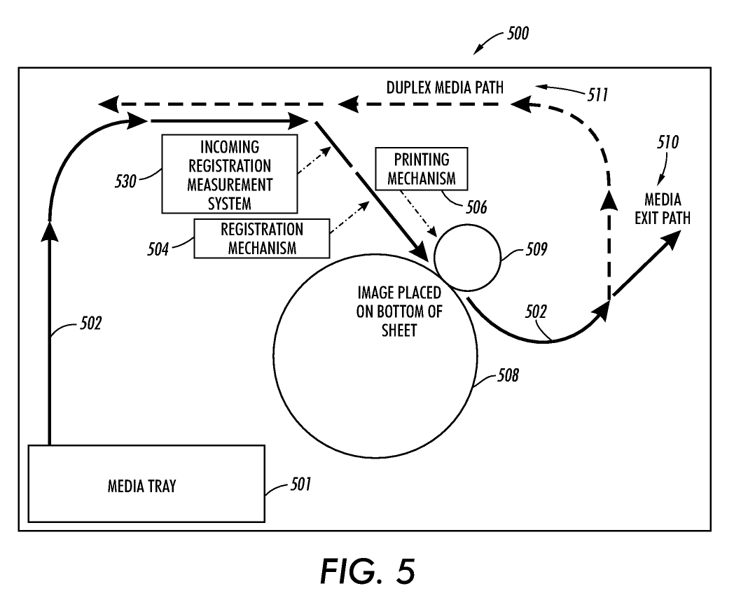

During the calibration process, a registration system 200 can register the media sheet 430 before feeding the sheet 430 into the imaging region of the print engine. A print engine incorporates a print head 506, as shown in FIG. 5. The print head 506 generates a calibration image on the drum 508 where it is then transferred onto the paper sheet 430 passing through the system. Then, the paper sheet 430 can be routed to the duplex media path 511 where the image side is inverted before being re-fed into the registration system 200. The registration system 200 can include a linear array sensor, which detects the placement of the calibration image, particularly image location features and edges of the paper sheet 430, allowing image placement offset assessment and determination of correction values by means of calibration algorithm. The calibration algorithm may include software instructions for executing the self-calibration operation.

The registration system 200 is adapted to detect whether registration errors such as skew, lateral and process errors are present and to what extent, in accordance with the instructions in the calibration algorithm. The registration system, comprising the registration measurement system 530 and registration mechanism 504 can calculate registration calibration values for the detected registration errors or offsets of the image relative to designated edges of the paper sheet 430. The registration sensing system 530 and the print engine can be electrically connected by a printer controller, which controls various printing functions provided by the printing device 100. The printer controller can make adjustments to the registration calibration values in order to correct the registration errors, such as position and angle offsets from the ideal, or the image on the paper sheet 430. The registration measurement system 530 and the duplex media path 511 along with a calibration image provided by a printing head 506 and the method of the present invention, enable automatic self-calibration of the registration process without intervention from the operator or adding additional sensors or detectors.

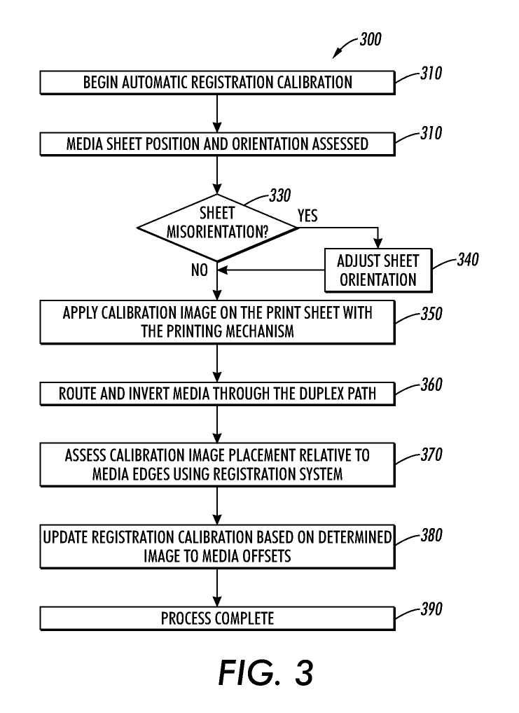

FIG. 3 illustrates a flowchart of an automated method 300 for image on media registration self-calibration using a duplex media path. The automatic registration and calibration process begins within a printing system at the point shown in Block 310. The media enters the paper path region where orientation and position registration is assessed, as shown in Block 320. If misregistration is detected, as shown in decision block 330, the sheets orientation and position is adjusted, as illustrated at block 340. As previously referenced, the methods employed to adjust the position and orientation of the media sheet have become somewhat commonplace and are not described herein. In offset printing, the media sheet is fed into the nip of a drum and pressure or fusing roller where the image created on the drum by the print head is transferred to the media sheet. The calibration image referred to in block 350 is created on the media by this method. The next step, block 360, in the automatic registration calibration process is to reroute and invert the media sheet through the duplex media path. As the media progresses through the duplex path, it may again be registered (optional) but this time the original or first pass registration, based on media edges, is compared against the calibration image 106 to determine offsets from nominal or the ideal, as indicated in block 370. Applying a calibration image to the second media side during this process is not required. As shown in block 380, image offsets from the ideal are determined and used to establish calibration values for the registration process. When the registration calibration values are first established or are different from previous values, they are updated in the control system and retained for future use. The basic process is then completed as shown in Block 390. It should be noted that repeating the calibration image and registration assessment process may increase nominal accuracy, obtainable, as example by averaging, which may include various weighting considerations such as quantity, media type, duty cycle, previous calibration values and the like. Repetition may include applying a calibration image 106 to the second side of the image in the duplex process and may also include multiple media sheets, each with at least a single side calibration image. Different images may be used for each side or sheet.

It can be appreciated that the foregoing method 300 of the invention can achieve automatic self-calibration using the registration system and the duplex media path without user measurement input, transferring the sheets to a scanning device or adding cost and complexity to the printing device.

It should be appreciated from the foregoing teaching that the calibration method 300 can correct the image on media registration error from a variety of sources and offsets or errors such as sensor mounting errors, drive roller location errors, roller diameter variations, differences in specific rollers that influence a media size or range of sizes, media path drag friction or drag, or other elements affecting accuracy of the registration system 200. It can also now be appreciated that the calibration method 300 can also compensate for other registration error influences and component and assembly tolerances, including those associated with the imaging process, image content, such as color, and media size, such as length, width and thickness or media type having various characteristics, such as material composition, stiffness, texture or weight. Media size variation encompasses the different media path rollers used for each given size since that roller combination may be more significant to registration than the media width. System errors, component location variations and other errors or offsets, such as those mentioned, contribute to an overall result that influences image location relative to media edges. When the sensed image position is assessed against the sensed media edges, all offset or location errors seen by the same sensing device are encompassed in calculating the required registration correction. The terms offset and errors in context with registration and registration calibration are to be considered synonymous. The correction therefore applies to all these factors as they influence the position of the media in the sensed region. Example: an expected side image edge to media edge relationship, 20 mm as example, may be measured as an actual distance of 19 mm with a normally registered media sheet due to system errors/offsets. If this is the result of the registration assessment process, the automatic calibration can account for this offset by readjusting the nominal media registered target position by that 1 mm distance, thereby achieving the desired 20 mm intent in this example. Some printers in the past have generated some type of calibration image that had to be manually measured or run through a scanner to accomplish a calibration correction; this method accomplishes that correction automatically and quickly.

Furthermore, such calibration method 300 can be run at any time without user interaction, since the calibration process can complete automatically. This can be done periodically based on some programmed metric, every “n” number of images or weekly or monthly, or at the beginning of batch jobs, as an example. It may also be performed at a specific time for a specific purpose as desired. For instance, an untrained user of the printer 100 can request an image on media calibration from the printer user interface (not shown) using the calibration method 300. The calibration process 300 may utilize more than one sheet in order to arrive at a more accurate correction and may also be done uniquely or individually for different sizes of media or different types of media or different weights of media. For example, a wide format printer may use a different calibration value for A3 size media than what is used for A4 size media. Media transport roller spacing may be one critical factor in establishing registration and registration calibration as media of some size variations may be influenced by common sets of rollers where other media sizes are influenced by subsets of those rollers or by additional rollers.

FIG. 5 illustrates a schematic representation for processing a calibration image on the paper sheet 430, which can be implemented in accordance with a preferred embodiment. As explained above, the paper sheet 430 includes a lateral edge 402, a first side lead edge 404, a second side lead edge 406, an inked lateral edge 414 and an inked lead edge 416. As the paper sheet 430 feeds from a media tray 501 through a media path 502 into the registration system 530, the edges are detected as normal to measure and correct the incoming position and orientation error. Thereafter, a calibration image is applied on a paper sheet 430 such that a nominal lateral distance 410 is created between the media lateral edge 402 and the inked lateral edge 414. Similarly, a nominal process distance 412 can be created between the media lead edge 404 and the inked lead edge 416. In an example printer, the built-in duplex media path can invert the media sheet and pass it again through the registration system 530 and the printing mechanism 506. When inverted, the image side is on the opposite side of the sheet 430 from the imaging drum 508, as referenced in FIG. 5. In an example printer, the duplex media path passes a sheet 430 in the second side transport direction, in which the initial media lead edge 404 now becomes the trailing edge. A registration sensor associated with the registration system 530 can detect the image to non imaged transition region, an edge which is effectively a definitive location line, as it passes under the sensor, thereby establishing image location.

Referring again to FIG. 5, a schematic view of a mechanical flow diagram for a printing system 500 including the active registration system 530 and the built-in duplex media path 502 of the present invention is illustrated, which can be implemented in accordance with a preferred embodiment. Initially, the paper sheet feeder associated with a media tray feeds the sheet into the media path 502 from the media tray 501 into the incoming registration measurement system 530 via the media path 502. The registration measurement system 530 measures the incoming registration errors and makes orientation and position adjustments with the registration mechanism 504. Registration may be accomplished in full or in part with components considered part of the media motion path, but for simplicity any such capability will be described as a registration mechanism 504. The sheet is then fed into the printing mechanism 506, where a calibration image is applied to the sheet 430. Then, the sheet 430 travels through the duplex media path 511 and re-enters the registration measurement system 530. During this pass through, both the sheet 430 edges and the reference edges of the calibration image are measured by the registration measurement system 530. Offsets from the intended distance between the reference edges of the calibration image and the sheet edges are then determined and by applying the calibration algorithm, become the registration correction calibration values.

Calibration values correct for offsets from the intended image to media position relationship that would otherwise occur when nominally registered. To briefly recap the previously described “process”, “lateral” and “skew” registrations and in context with the calibration objective, position of the image on media in the process direction is its distance from an edge in that axis of travel, most generally, the top edge based on the image viewing orientation with measurement determination taken at a point somewhat near one of the side edges, the left side as example. The calibration for this value is an amount of offset correction that would be applied to the nominal registration position of the media prior to imaging to achieve the intended image to media alignment, which as referenced, is a distance from a point along the top edge. The lateral calibration is likewise a distance correction for the spacing of the image relative to one image side and may be applicable at one location, 25 mm from a leading edge and along the left side or typical controlling margin, as example. The skew calibration is similar to the process offset correction except that it generally applies, in an example case, at the top edge at the process measurement point and second point nearer the opposite side of the media from the process measurement location. If the two measurements from the top edge are different, that sheet edge is skewed or angled relative to the feed trajectory. Skew calibration can provide a compensation for the angular error attained in nominal media positioning during registration prior to applying the calibration value. In alternatives, a side edge or regions along a combination of side and end edges may be used in determining skew. This may be advantageous for various sizes of media to obtain an improved aspect ratio.

In the printer example, the duplex media path 511 not only inverts or flips the sheet 430 over, but reverses it end for end, the first side lead edge 404 of the sheet 430 becomes the trailing edge rather than leading edge. The second side lead edge 406 of the sheet 430 enters the registration measurement system 530 first, but it is the original lead edge, now trailing, that is preferably used for distance measurement relative to the reference edges of the calibration image. Nominal calibration image orientation and placement on the sheet can be easily configured for optimization of the calibration process with an alternative duplex system where the same edge leads in the first and duplex pass.

A linear array registration sensor is described in the present example. This sensor array can span all or portions of the applicable width of the media and image and therefore is used to detect process and lateral edges of the media and image target regions. As the calibration image progresses through the registration measurement process, the inked lateral edge 414 passes underneath the registration sensor associated with registration system 530. The sensor can detect the position of the transition from light (i.e. white or light paper) and dark (i.e. black, dark or sufficiently contrasting colored ink), the accuracy of which may be improved by incorporating a “black” level reference image region 408 in the calibration image. The lateral position of the inked lateral edge 414 is recorded as the lateral edge of the media, this data to be used in subsequent calculations for calibration. Similarly, the inked lead edge 416 passes underneath the registration sensor when the sheet 430 continues farther through the registration mechanism 504.

As the calibration image passes under the sensor, the sensor can detect the process position of the transition from light to dark at two or more locations across the inked lead edge 416, the accuracy of which may be improved based on the black level reference. The transitions are utilized to calculate the skew and process position of the inked lead edge 416. The skew and process positions of the inked lead edge 416 are recorded along with corresponding edges of the media for subsequent calibration calculations. Alternate sensor types and configurations are compatible with the present registration and calibration process. As example, two simple sensors capable of detecting media edge and light-dark image transitions can be employed for process and skew measurement and registration as both are accomplished by passing the media across a stationary sensor. Such a sensor can also be used for lateral measurements when mounted to a translation device. Other stationary sensors can be used for the lateral measurement, such as a smaller linear array. In another alternative sensor example, process, lateral and skew measurements may be made with one or more cameras using known optical pattern recognition methods.

Finally, the sheet 430 continues through the printer out through a media exit path 510. Calibration values, which are the image registration offsets from nominal, can be calculated using data from the calibration image and media registration system measurements with equations (1), (2) and (3).

Skew Error=(first side lead edge skew)−(inked lead edge skew) (1)

Process Error=(first side media lead edge process position)−(inked lead edge process position)−(nominal process distance) (2)

Lateral Error=(media lateral edge lateral position)−(inked lateral edge lateral position)−(nominal lateral distance) (3)

There are numerous variations to the calibration process. As example, printing system 500 can apply a different calibration image 400 to the second side 406 of the sheet 430. Then, the different calibration image 400 pattern or image elements 420 can be sensed when the sheet 430 passes through the registration system 530. Therefore, the registration system 530 can achieve two sets of error measurements for one sheet 430. In this variation, the second measurement could be compared with the first to establish a measurement weighting from two different images rather than simply averaging data from two similar measurements. Another variation would be to modify the calibration image lay down position for a second imaging pass based on the calibration error or offset detected with a first pass so that the image was placed ideally relative to registered media edges. That calibration image could then be assessed after a second pass for correct media edge relationship, with the calibration value further adjusted as needed. In yet another variation, the calibration image may have multiple edge transitions that factor into the calculation. Another variation is to use the leading media edge as the position reference during the first measurement system pass and the opposite end edge for the second measurement pass by determining media length during the first pass. This can be done by assessing travel distance between the leading and trailing edges.

It will be appreciated that numerous additional variations of the above-disclosed elements and methods and other features and functions, or alternatives thereof, may be desirably employed or combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method providing automatic self-calibration of media registration for image placement on at least one media sheet using a built-in duplex media path, said method comprising:
providing a printing system including a registration system including at least one registration sensor, a duplex media path, a printer controller, a calibration image and a calibration algorithm;
registering at least one media sheet based on registration system data and correcting media sheet orientation and placement as needed;
placing the calibration image on said at least one media sheet after registration;
inverting the at least one media sheet in the duplex media path, and re-feeding said at least one media sheet into the registration system; and
detecting and measuring placement accuracy of the calibration image on the at least one media sheet using said registration system, and adjusting one or more system settings as needed based on the registration measurement data to compensate for one or more system errors degrading accuracy of image to media alignment.

2. The method of claim 1 wherein said printer controller adjusts said one or more system settings as determined by said calibration algorithm in order to automatically correct said at least one registration error.

3. The method of claim 1 wherein said at least one media sheet is fed into a printing mechanism in a print engine such that said at least one calibration image is applied to said at least one media sheet.

4. The method of claim 1 wherein said at least one registration sensor captures image data of said at least one calibration image of said at least one media sheet.

5. The method of claim 1 wherein said at least one registration sensor comprises a scan bar and/or single linear array sensor.

6. The method of claim 1 wherein said at least one registration error comprises a skew error, a process error and a lateral error.

7. The method of claim 1 wherein said at least one registration sensor comprises multiple sensors of equivalent or different types.

8. The method of claim 1 wherein said registration system is utilized individually for a different size of media or different type of media or different weight of media.

9. A method for registration self-calibration of an image on at least one media sheet using a duplex media path built-in to a printing system, said method comprising:
providing a printing system including a registration system including at least one registration sensor, a duplex media path, a printer controller, a stored calibration image and a calibration algorithm;
registering at least one media sheet by adjusting orientation and position of the at least one media sheet as needed based on registration data from the registration system;
placing at least one calibration image on the at least one media sheet;
inverting said at least one media sheet within the duplex media path, and feeding the at least one media sheet back into the registration sensing system;
optionally sensing media edges and re-registering the at least one media sheet bearing the at least one calibration image in the registration mechanism;
detecting and measuring placement accuracy of the at least one calibration image on the at least one media sheet using said registration sensing system, determining if an image location error exists; and
adjusting one or more printer settings based on calibration algorithm offset values if a registration error is detected by said registration system.

10. The method of claim 9 wherein said registration self-calibration is programmed to occur automatically based on user selected metrics related to printer operation.

11. The method of claim 9, wherein said at least one registration sensor captures image location data of said at least one calibration image of said at least one media sheet during the step of detecting and measuring placement accuracy of the at least one calibration image on the at least one media sheet.

12. The method of claim 1 wherein said at least one registration sensor comprises a scan bar and/or single linear array sensor.

13. A system for registration self-calibration of image placement on at least one media sheet using a built-in duplex media path, said method comprising:
a registration system including at least one registration sensor and a calibration algorithm, said registration system adapted to register at least one media sheet during a system calibration process and measuring location of image features of at least one calibration image applied on the at least one media sheet;
a duplex media path adapted to invert the at least one media sheet within the duplex media path and re-feed the at least one media sheet into said registration sensing region; and
one or more detectors adapted to measure the accuracy of placement of the at least one calibration image on the at least one media sheet using said registration system;
wherein said system is adapted to provide data enabling a registration calibration algorithm to establish registration correction settings in response to determining one or more registration errors as detected by said registration system.

14. The system of claim 13, wherein said registration sensing system is associated with a printer controller wherein said printer controller is adapted to adjust settings of said registration calibration in order to automatically correct said at least one registration error.

15. The system of claim 13 wherein said at least one media sheet is fed into a printing mechanism in a print engine such that said at least one calibration image is applied to multiple media sheet surfaces so that calibration accuracy may be improved by averaging.

16. The system of claim 13 wherein said registration self-calibration is programmed to execute automatically based on printer operation metrics.

17. The system of claim 13 wherein said at least one registration sensor comprises a scan bar and/or single linear array sensor.

18. The system of claim 13 wherein said calibration compensates for at least one registration error comprising a skew error, a process error and a lateral error.

19. The system of claim 13 wherein said method corrects a variety of error influences such as sensor mounting errors, drive roller location errors, roller diameter variations, media path drag errors, misplaced or skewed print head or image trajectory errors, imaging drum mounting errors, media size, media type, image color or image distortion due to imaging process.

20. The system of claim 13 wherein said registration system is utilized individually for a different size of media or different type of media or different weight of media.
